(19) United States
(12) Patent Application Publication
(10) Pub. No.: US 2026/0016229 A1
(43) Pub. Date: Jan. 15, 2026

(54) IMPROVED SINTERING OR INDURATION BELT FOR SINTER OR PELLET PLANTS

(71) Applicant: PAUL WURTH S.A., Luxembourg (LU)

(72) Inventor: Jean GÉRARD, Thionville (FR)

(21) Appl. No.: 19/137,920

(22) PCT Filed: Jun. 12, 2023
(86) PCT No.: PCT/EP2023/084465

§ 371 Date: Jun. 11, 2025

(30) Foreign Application Priority Data
Dec. 15, 2022 (LU) LU503196

(51) Int. Cl. F27B 21/06; F27D 5/00; F27D 99/00

(52) U.S. Cl. CPC F27B 21/06; F27D 5/0068; F27D 99/0076

(57) ABSTRACT

A sintering belt (10) comprising a chain of grate cars (12); a supporting structure configured to support and allow movement of the chain of grate cars (12); at least two longitudinal sealing elements, parallel to a direction of motion (D) of the chain of grate cars (12) along the sintering or induration belt (10); at least two transversal sealing elements (14), intersecting with the direction of motion (D) of the chain of grate cars (12) along the sintering or induration belt (10), and partially obstructing its motion; and at least one suction duct (16). The suction duct (16), the at least two longitudinal sealing elements, the at least two transversal sealing elements (14) and a bottom surface of grate cars (12) are configured to define at least one plenum chamber (PC). The suction duct (16) is further configured to generate an under or over pressure in said plenum chamber (PC). A transversal sealing element (14) comprises at least one sealing roll (18, 18.1-18.15), the sealing roll (18, 18.1-18.15) configured to partially obstruct the motion of the chain of grate cars (12), and the sealing roll (18, 18.1-18.15) comprising an inner roll (18a) defining an inner radius and an elastically deformable outer sleeve (18b) defining an outer radius, and a transversal sealing element (14) comprises a plurality of parallel sealing rolls (18, 18.1-18.15) defining at least one roller table (20). A roller table (20) comprises at least two engaging sealing rolls (18.1-18.5), such that the distance between two adjacent engaging sealing rolls (18.1-18.5) is strictly comprised between the sum of their inner radii and the sum of their outer radii, consecutive engaging sealing rolls (18.1-18.5) defining a continuous surface (20′) of the roller table (20).

### CROSS-REFERENCE TO RELATED APPLICATIONS

This application is a 35 U.S.C. § 371 National Stage patent application of PCT/EP2023/084465, filed on 6 Dec. 2023, which claims the benefit of Luxembourg patent application no. 503 196, filed on 15 Dec. 2022, the disclosures of which are incorporated herein by reference in their entirety.

### TECHNICAL FIELD

The present disclosure generally relates to sinter or pellet plants. More specifically, the disclosure relates to a sintering or induration belt with improved durability and lower operating costs.

### BACKGROUND

Sinter plants are widely used to agglomerate fine materials into sinter usable in a blast furnace.

A sinter/pellet plant typically comprises a mixing drum and a hopper to mix different fine materials in the desired proportions, a sintering or induration belt (the belt is called induration belt if pellet are processed), to carry the mixture of fine materials, and an ignition hood near the upstream end of the belt or strand to ignite a portion of the fine materials. At the end of the belt, the resulting aggregate material may be crushed and cooled before storage.

Traditionally, the belt comprises a chain of contiguous grate cars to carry the mixture of fine materials, a supporting structure to support and allow movement of the chain of grate cars along the belt, at least two longitudinal sealing elements, at least two transversal sealing elements and at least one suction duct. The bottom surface of the cars in the chains of grate cars is configured to allow flow of gas whilst preventing passage of fine materials.

The suction duct, the longitudinal and transversal sealing elements, and the bottom surface of the chain of grate cars are configured to define at least one plenum chamber. The suction ducts are further configured to generate an under or over pressure in said plenum chambers. Therefore, when a pressure differential is generated by the suction duct, a gaseous flow is generated through the bottom surface of the chain of grate cars and through the mixture of fine materials therein. If part of the fine materials was previously ignited by the ignition hood, such a flow may support propagation of the flame though the mixture.

Commonly, the transversal sealing elements comprise adaptative plates capable of adjusting their elevation to allow passage of an incoming grate car whilst ensuring minimal or no gap with said grate car to achieve tightness (i.e. ensure no false air can enter/escape the plenum chamber in a gap between the grate cars and the transversal sealing element). If there is no gap, the contact pressure required to ensure tightness contributes to the abrasive wear caused by friction between the adaptative plate and the grate cars. This contact is also prone to block the movement of the chain. However, if even a small gap is formed on the adaptative plate, extreme sandblasting wear may occur due to high pressure differential and presence of fine material in the gaseous flow. The dimensions of such a gap may then increase by multiple orders of magnitude, enabling flow of large quantities of false air.

### SUMMARY

The present disclosure provides a sintering or induration belt for sinter or pellet plants that is more durable, less susceptible to abrasive and sandblasting wear, easier to maintain and minimizes flow of false air.

This is achieved by providing a sintering or induration belt as recited in the independent claim.

In order to overcome the above-mentioned problem, a sintering or induration belt for transport of a load through a sinter or pellet plant comprises:
a chain of grate cars having a bottom surface,
a supporting structure configured to support and allow movement of the chain of grate cars,
at least two longitudinal sealing elements, parallel to a direction of motion of the chain of grate cars along the sintering or induration belt,
at least two transversal sealing elements, intersecting with the direction of motion of the chain of grate cars along the sintering or induration belt, and partially obstructing its motion, and
at least one suction duct.

The suction duct, the at least two longitudinal sealing elements, the at least two transversal sealing elements and the bottom surface of grate cars are configured to define at least one plenum chamber. In particular, the suction duct ensures tightness at the bottom end of plenum chamber, the longitudinal sealing elements ensure tightness on the lateral sides, the transversal sealing elements ensure tightness at the upstream and downstream ends, and the contiguity of grate cars ensure partial tightness at the top end.

The suction duct is further configured to generate an under or over pressure in said plenum chamber.

A transversal sealing element comprises at least one sealing roll, the sealing roll configured to partially obstruct the motion of the chain of grate cars, and the sealing roll comprising an inner roll defining an inner radius and an elastically deformable outer sleeve defining an outer radius.

The advantages of using the sealing rolls according to the disclosure are multiple.

Firstly, sealing rolls are unlikely to completely block motion of the grate cars. Indeed, even if an incoming grate car is worn and its elevation is lower than expected, its trajectory will be corrected upon contact with a sealing roll and deformation of its outer sleeve.

Secondly, the use of sealing rolls localizes the contact of the grate car against the transversal sealing element in a smaller area, thereby allowing higher contact pressure for improved tightness. Tightness is further improved by the use of a soft or flexible material in the outer sleeve.

Thirdly, as sealing rolls are able to spin in response to friction applied by motion of the grate cars, the overall abrasive wear on the transversal sealing element is reduced, even is the material is sensitive to wear. Moreover, abrasive wear is distributed onto the outer sleeve. Sealing rolls can thus be easily maintained by simply fitting a new outer sleeve onto their inner roll.

A transversal sealing element comprises a plurality of parallel sealing rolls defining at least one roller table. Using multiple rolls further enhances the aforementioned technical effects and allows for various configurations as discussed below.

According to the disclosure, a roller table may comprise at least two engaging sealing rolls, such that the distance between two adjacent engaging sealing rolls is strictly comprised between the sum of their inner radii and the sum of their outer radii, consecutive engaging sealing rolls defining a continuous surface of the roller table. Tightness between engaging sealing rolls is ensured by contact pressure between their outer sleeves or by intermeshing of their outer sleeves.

Preferably, grate cars of the chain of grate cars comprise rigidifying beams extending transversally on the bottom surface of the grate cars, so that in operation, the transversally extending rigidifying beams come into contact with sealing rolls, when the grate cars pass over the sealing rolls. The diameter and/or the pitch of engaging sealing rolls of a continuous surface is preferably selected such that the chain of grate, which spins rolls due to frictional force, is unable to spin two or more engaging rolls in rotating directions incompatible with their natural gearing. As adjacent engaging rollers within a continuous surface spin in opposite directions at any given time, this configuration prevents abrasive wear between adjacent engaging rollers. Note that with this configuration the rotation of each roller oscillates as transversal rigidifying beams of the grate cars travel through the continuous surface.

Preferably, continuous surfaces comprise an odd number of engaging sealing rollers. As the rotation of each roller oscillates as grate cars travel through the continuous surface, having an even number of rollers may result in only a narrow portion of the outer sleeve being repeatedly in contact with the grate cars. This would result in an outer sleeve that is intact on most of its circumference but quickly worn out on said narrow portion.

The sintering or induration belt may comprise complementary rotation drivers to improve transfer of torque between sealing rolls. Complementary rotation drivers ensure sealing rolls are spinning in their intended direction, thus reducing friction and abrasive wear, particularly between adjacent engaging sealing rolls.

The complementary rotation drivers may be selected from gears, motors and outgrowth on inner rolls.

A roller table may comprise at least two non-engaging sealing rolls, such that the distance between two adjacent non-engaging sealing rolls is equal to or greater than the sum of their outer radii, consecutive non-engaging sealing rolls defining a discontinuous surface of the roller table. As non-engaging sealing rolls have only one rotating direction, multiple sealing rolls within a discontinuous surface may be driven by a single motor and a belt.

Such a discontinuous surface may comprise a complementary sealing element, configured to prevent flow of gas between the non-engaging sealing rolls, through the discontinuous surface.

Such complementary sealing elements may be selected from a transversal sealing pad, a sealing bottom portion, and complementary sealing rollers.

Preferably, each grate car comprises at least one, preferably at least two transversal rigidifying beams extending transversally on the bottom surface of the grate cars, so that in operation, the transversally extending rigidifying beams come into contact with sealing rolls, when the grate cars pass over the sealing rolls. The transversal rigidifying beams preferably comprise a longitudinal extrusion at their bottom end. Transversal rigidifying beams are able to localize the force applied by the grate car to the rollers, improving the tightness between the rollers and the grate cars. Longitudinal extrusions further improve the tightness between the rollers and the grate cars by ensuring contact with the rollers throughout the motion of the grate car.

The outer sleeve may be made of a soft or flexible material, such as rubber or brush-like materials. Such outer sleeves improve tightness between sealing rollers of a continuous surface, and generally improve tightness between sealing rollers and grate cars.

At least one rotation sensor may be arranged to detect rotation of a sealing roller. By monitoring the rotation of rollers, faulty rollers can be identified and maintenance operations planned accordingly.

The longitudinal sealings elements may be scraping sealing pads.

Preferably, the bottom surface of at least one car of the chain of grate cars is configured to allow flow of gas and prevent passage of the load.

### BRIEF DESCRIPTION OF THE DRAWINGS

Further details and advantages of the present disclosure will be apparent from the following detailed description of not limiting embodiments with reference to the attached drawing, wherein:

FIGS. 1a and 1b are cross sections of embodiments of sintering or induration belts according to the prior art and to the disclosure, respectively;

FIGS. 2a, 2b, 2c, 2d and 2e are schematic views of an embodiment with a continuous section according to the disclosure at different stages in the motion of a grate car; and

FIGS. 3a, 3b, 3c are schematic views of embodiments with different discontinuous sections according to the disclosure

### DETAILED DESCRIPTION OF THE DRAWINGS

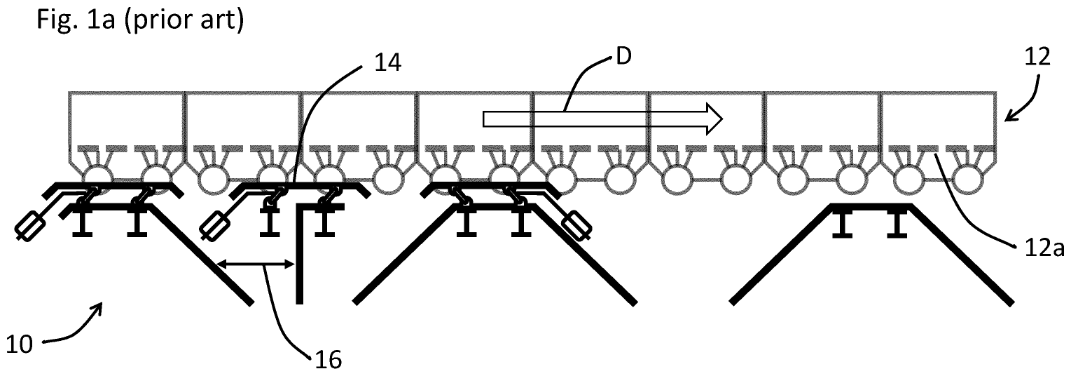

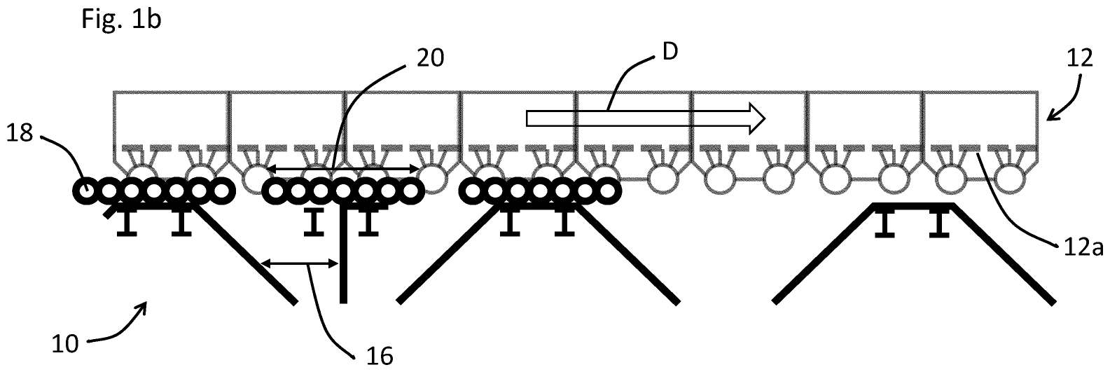

FIGS. 1a and 1b show cross sections of embodiments of sintering or induration belts 10 according to the prior art and to the disclosure, respectively.

In both embodiments, the belt 10 comprises a chain of grate cars 12 having wheels 12a supported by rails (not shown) on a supporting structure. The rails support the cars 12 and enable their movements in a transport direction D along the belt. The grate cars have a bottom surface 12a configured to allow flow of gas and prevent passage of the load through their bottom surface 12a.

Furthermore, longitudinal sealing elements (not shown) are arranged in vertical-longitudinal planes on both sides of the belt 10, whilst suction ducts 16 are arranged below and along the chain of grate cars 12.

FIG. 1a and FIG. 1b differ in that in FIG. 1a, a plurality of adaptative plates is arranged along the transport direction D. The adaptative plate are configured to adjust their elevation to allow passage of an incoming grate car 12 whilst providing sufficient contact pressure or minimal gap to manage tightness.

Meanwhile, in FIG. 1b, a plurality of sealing roller tables 20 is arranged along the transport direction D. The sealing rollers 18 of the roller tables 20 comprise an inner roll 18a and an outer sleeve 18b made of a brush-like material. Rollers 18 within a roller table 20 are arranged parallel to each other perpendicular to the transport direction D. The outer sleeve 18b of each roller 18 is engaged with the outer sleeves 18b of two other rollers 18 (or a single other roller 18 in the case of rollers at the extremities of the roller table 20). Gas flow between rollers 18 is thus prevented.

The roller tables 20 are further configured to partially obstruct the path of the grate cars 12 such that upon contact between an incoming grate car and the upstream-most roller of the roller table 20, the grate car 12 moves upwards along the curvature of said roller 18. Eventually, the weight of the grate car 12 compresses the outer sleeves 18b of the sealing rollers 18 of the roller table 20, thereby preventing gas flow between the grate car 12 and the rollers 18.

Hence both the plurality of adaptative plates of FIG. 1a and the plurality of roller tables 20 of FIG. 1b act as transversal sealing elements 14 in their respective embodiments.

The transversal sealing elements 14, the longitudinal sealing elements, the bottom surface 12a of the plurality of grate cars 12 and the suction ducts 16 are arranged so as to define a plurality of plenum chambers PC below the chain of grate cars 12. Hence, when an under or over pressure is generated in a plenum chamber PC by a suction duct 16, the only flow path available to the gas is through the bottom surface 12a of the grate cars 12 and through fine materials loaded therein.

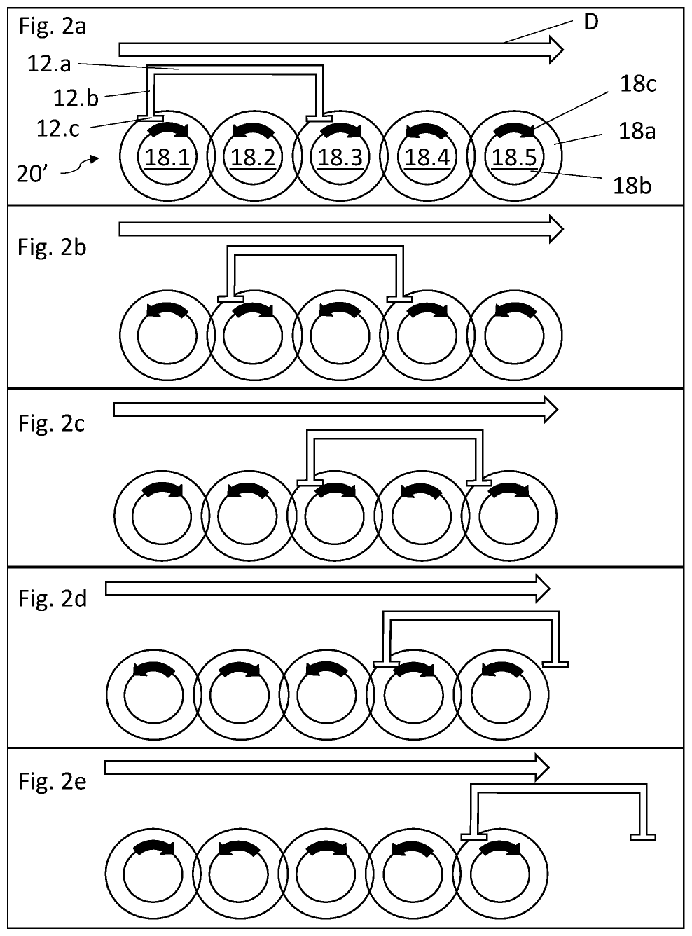

FIGS. 2a to 2e show schematic views of an embodiment with a continuous surface 20′ according to the disclosure. In particular, FIGS. 2a to 2e show the direction of rotation 18c of engaging rollers 18.1-18.5 at different stages of the motion of a grate car along the roller table. Said grate car (not fully represented) travels along the transport direction D and has a bottom surface 12.a and a pair of transversal rigidifying beams 12.b ending with a longitudinal extrusion 12.c. As it can be seen on FIGS. 2a, 2c, 2e, when the grate car moves to the right and is in contact with odd-numbered (18.1, 18.3, 18.5) sealing rollers, said rollers rotate clockwise, whilst even-numbered (18.2, 18.4) sealing rollers rotate counter clockwise. Conversely, as seen on FIGS. 2b, 2d, when the grate car moves to the right and is in contact with even-numbered (18.2, 18.4) sealing rollers, said rollers rotate clockwise, whilst odd-numbered (18.1, 18.3, 18.5) sealing rollers rotate counter clockwise. Therefore, the rotation of the rollers oscillates as the grate car progresses along the direction of motion D. The intermeshing of the outer sleeves 18b of the sealing rollers 18.1-18.5 prevent gas flow through the continuous surface 20′, i.e. between the sealing rollers. Likewise, the longitudinal extrusion 12c of the grate car and the outer sleeves 18b of the sealing rollers 18.1-18.5 cooperate to prevent gas flow between the sealing table and the grate car.

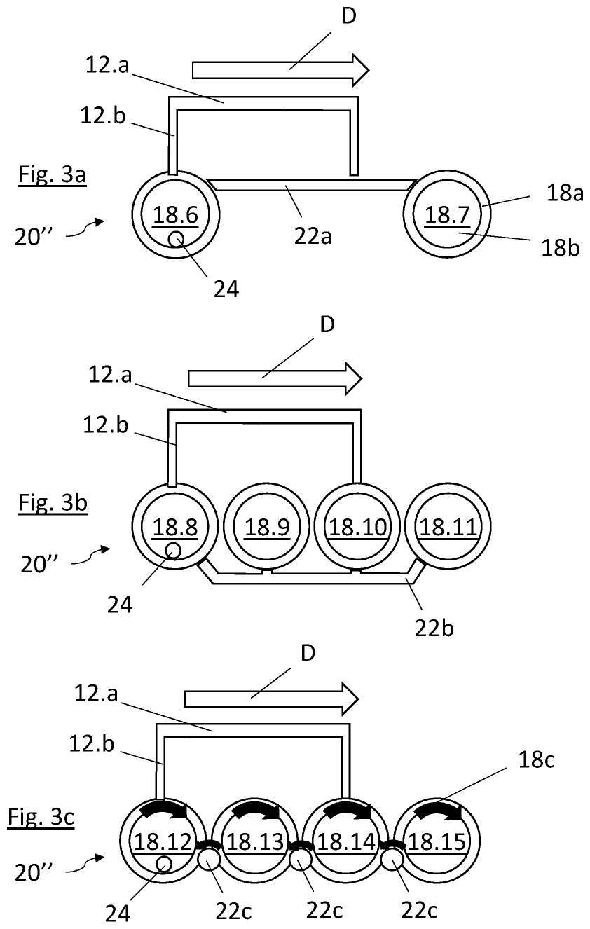

FIGS. 3a to 3c show various embodiments with different discontinuous surfaces 20″ according to the disclosure. In particular, FIG. 3a shows a table having two sealing rollers 18.6, 18.7 with a transversal sealing pad 22a, FIG. 3b shows a table having four rollers 18.8-18.11 interconnected by a sealing bottom portion 22b, and FIG. 3c shows a table having four rollers 18.12-18.15 and complementary sealing rollers 22c therebetween. The transversal sealing pad 22a of FIG. 3a, the sealing bottom portion 22b of FIG. 3b and the complementary sealing rollers 22c of FIG. 3c prevent gas flow between the sealing rollers 18.6-18.15 of their respective discontinuous surfaces 20″. Furthermore, the complementary sealing rollers 22c of FIG. 3c act as complementary rotation drivers able to transfer torque between sealing rolls 18.12-18.15, such that all sealing rollers 18.12-18.15 rotate in the same direction 18c. The embodiments of FIGS. 3a to 3c further comprise a rotation sensor 24, which is configured to monitor the rotation of a sealing roller.

The embodiments discussed above are purely exemplary and do not exclusively restrict the scope of the disclosure. In particular, it is noted that the subject matter of the disclosure includes combinations of the embodiments disclosed, such as roller tables 20 comprising both one or more continuous surface 20′ and one or more discontinuous surface 20″.

1. A sintering or induration belt for transport of a load through a sinter or pellet plant, comprising:
a chain of grate cars having a bottom surface;
a supporting structure configured to support and allow movement of the chain of grate cars;
at least two longitudinal sealing elements, parallel to a direction of motion of the chain of grate cars along the sintering or induration belt;
at least two transversal sealing elements, intersecting with the direction of motion of the chain of grate cars along the sintering or induration belt, and partially obstructing its motion;
at least one suction duct;
wherein the suction duct, the at least two longitudinal sealing elements, the at least two transversal sealing elements and the bottom surface of grate cars are configured to define at least one plenum chamber;
wherein the suction duct is further configured to generate an under or over pressure in said plenum chamber;
wherein a transversal sealing element-comprises at least one sealing roll, the sealing roll configured to partially obstruct the motion of the chain of grate cars, and the sealing roll comprising an inner roll defining an inner radius and an elastically deformable outer sleeve defining an outer radius;
wherein a transversal sealing element comprises a plurality of parallel sealing rolls defining at least one roller table;
wherein a roller table comprises at least two engaging sealing rolls, such that the distance between two adjacent engaging sealing rolls is strictly comprised between the sum of their inner radii and the sum of their outer radii, consecutive engaging sealing rolls defining a continuous surface of the roller table.

2. The sintering or induration belt according to claim 1, wherein grate cars of the chain of grate cars comprise rigidifying beams extending transversally on the bottom surface of the grate cars, so that in operation, the transversally extending rigidifying beams come into contact with sealing rolls, when the grate cars-pass over the sealing rolls; and wherein the diameter and/or the pitch of engaging sealing rollers of a continuous surface is selected such that the chain of grate cars, which spins rolls due to frictional force, is unable to spin two or more engaging rolls in rotating directions incompatible with their natural gearing.

3. The sintering or induration belt according to claim 1, comprising an odd number of engaging sealing rollers defining said continuous surface.

4. The sintering or induration belt according to claim 1, further comprising complementary rotation drivers to improve transfer of torque between sealing rolls.

5. The sintering or induration belt according to claim 4, wherein the complementary rotation drivers are selected from gears, motors and outgrowth on inner rolls.

6. The sintering or induration belt according to claim 1, wherein a roller table-comprises at least two non-engaging sealing rolls, such that the distance between two adjacent non-engaging sealing rolls is equal to or greater than the sum of their outer radii, non-engaging sealing rolls defining a discontinuous surface of the roller table.

7. The sintering or induration belt according to claim 6, further comprising a complementary sealing element, configured to prevent flow of gas between the non-engaging sealing rolls, through the discontinuous surface.

8. The sintering or induration belt according to claim 7, wherein the complementary sealing elements are selected from a transversal sealing pad, a sealing bottom portion, and complementary sealing rollers.

9. The sintering or induration belt-according to claim 1, wherein each grate car comprises at least one, preferably at least two transversal rigidifying beams, the transversal rigidifying beams extending transversally on the bottom surface of the grate cars, so that in operation, the transversally extending rigidifying beams come into contact with sealing rolls, when the grate cars pass over the sealing rolls, the transversal rigidifying beams preferably comprising a longitudinal extrusion at their bottom end.

10. The sintering or induration belt according to claim 1, wherein the outer sleeve of a sealing roll is made of a soft or flexible material, such as rubber or brush-like materials.

11. The sintering or induration belt according to claim 1, wherein at least one rotation sensor is arranged to detect rotation of a sealing roller.

12. The sintering or induration belt according to claim 1, wherein the longitudinal sealings elements are scraping sealing pads.

13. The sintering or induration belt according to claim 1, wherein the bottom surface of at least one car of the chain of grate cars is configured to allow flow of gas and prevent passage of the load.
